(19) United States
(12) Patent Application Publication
(10) Pub. No.: US 2016/0235139 A1
(43) Pub. Date: Aug. 18, 2016

(54) ELECTRICALLY HEATED GLOVES

(71) Applicant: David Gramlin, New Albany, IN (US)

(72) Inventor: David Gramlin, New Albany, IN (US)

(21) Appl. No.: 15/044,360

(22) Filed: Feb. 16, 2016

Related U.S. Application Data
(60) Provisional application No. 62/116,613, filed on Feb. 16, 2015.

(51) Int. Cl. A41D 19/015; H05B 3/34; H05B 3/00; A41D 19/00

(52) U.S. Cl. CPC A41D 19/01535; A41D 19/0037; H05B 3/342; H05B 3/0014

(57) ABSTRACT

A garment for wearing in cold weather, such as gloves, wherein the garment is electrically heated to provide resistive warmth to the wearer and where the garment has multiple layers and where the heating element is disposed between the inner and the outer layers, yet secured by loop fastening features.

### CROSS-REFERENCE TO RELATED APPLICATION

This U.S. patent application claims priority to U.S. Provisional Application 62/116,613 filed Feb. 16, 2015, the disclosure of which is considered part of the disclosure of this application and is hereby incorporated by reference in its entirety.

### FIELD OF THE INVENTION

This invention relates generally to heated garments. In one aspect, the current invention is related to electrically heated gloves relying on battery technology.

### BACKGROUND

In the garment industry, it is known to provide some form of auxiliary heat to certain garments that will be used in cold weather environments, whether for work, sport, or other settings. For example, skiers have long used hand warmers based on chemical reactions between reactants such as iron, activated carbon, and water. Further, glove manufacturers have begun adding electrical heating features to gloves, such as those that are based on some rechargeable battery technology.

A persistent problem with existing technology is sufficient warmth combined with ability to perform working tasks, such as picking up and holding smaller items (e.g., screws and nuts) or connecting hoses and wires. This problem is particularly pronounced in far northern and southern regions of the world where temperatures are commonly well below 0° F.

There exists a need to provide a glove that comprises an improved flexible resistive element\wire and a rechargeable battery to provide a battery-powered, heated glove or other garment, suitable for rugged use in a work environment garment with a loop securing feature.

### BRIEF SUMMARY OF THE INVENTION

In one aspect, this disclosure is related to a heated glove suitable for use in cold temperature environments comprising a hand region; multiple appendage regions; a battery housing region; an inner layer; an outer layer; a heating element disposed between the inner layer and the outer layer, wherein the heating element includes a coiled feature in each appendage region and a pattern thought the hand region, and wherein the heating element is electrically connected to the battery housing region, and wherein the heating element is electrically isolated. The heated glove can further use a loop securing feature between the inner layer and the outer layer of the glove.

The loop securing feature is used for the securing of the heating element within the glove while facilitating the flexibility of the heating element to be able to move though the loop securing feature without causing excess tension and pulling of the heating element when the wearer flexes his hand and therefore stretches the glove. In other words, the loop securing feature is used to hold the heating element to the inner layer of the glove, yet the heating element may slide or otherwise move within the inner layer of the glove without being physically attached to any particular layer of the glove itself.

### BRIEF DESCRIPTION OF THE DRAWINGS

The features and advantages of this disclosure, and the manner of attaining them, will be more apparent and better understood by reference to the following descriptions of the disclosed system and process, taken in conjunction with the accompanying drawings, wherein:

FIG. 1 is a view of an exemplary embodiment of a glove according to this disclosure with the outer layer removed to reveal the workings of the glove.

FIG. 2 is a view of an exemplary embodiment of a glove according to this disclosure with partial outer glove completing the finished glove.

FIG. 3 is a layered cutaway view of an exemplary embodiment of a glove on a user's hand.

FIG. 4 is a magnified view of a battery compartment and bottom perspective of an exemplary embodiment of the glove.

FIG. 5 is a side perspective view of an exemplary embodiment of a glove according to the disclosure in a “hand flexed” setting to demonstrate the flexibility and robust nature of the glove.

### DETAILED DESCRIPTION OF THE INVENTION

The Figures illustrate exemplary embodiments of an electrically heated glove described in this disclosure. It is to be generally understood that the nomenclature used herein is simply for convenience and the terms used to describe the invention herein should be given the broadest meaning by one of ordinary skill in the art.

The invention is directed to a battery powered, electrically heated glove that are suitable for a real world work-environment that provides heating to the full hand and each finger using coiled heating elements that are robust, yet flexible. The heated glove enables persons performing manual labor in freezing, or especially sub-0° F., environments to be able to work in comfort with warm hands and fingers.

The heated gloves comprise gloves that are suitable for performing manual labor, i.e., do not appreciably diminish the dexterity, sensitivity, or mobility of the hand to perform common manual tasks involving tools, machinery, and other necessary outdoor activities. Accordingly, unlike gloves known in the art, the gloves themselves primarily comprise fabric and a heating element in the hand and finger portions, and does not comprise excessive insulating material. That is, the gloves utilize fabric such that the glove conforms in high fidelity to the wearer's hand. In contrast, gloves of the prior art incorporate excess material to add insulation and facilitate use of chemical hand-warming packages.

The heated gloves are electrically isolated and rely on at least one battery to provide the necessary energy. In one exemplary embodiment, the battery can be a rechargeable battery. The battery powers a circuit of warming coils that are particularly oriented to maximize heat generation via resistive principles as the energy flows through the heating element. The heating element may be made of any suitable material that facilitates heating based on resistive principles, is flexible, yet robust. In one embodiment, the material of the heating element is NiCr-based. The heating element is configured to warm the wearer's entire hand and each finger and thumb.

The heating element is designed such that it is electrically isolated, therefore preventing a short in the circuit, permitting the gloves to be used around conductive material and electrical environments without risk of electrical shock. The heating element can be comprised of any suitable material. In one embodiment, the conductive material of the heating element can be coated with a durable rubber coating. The rubber coating on the heating element means that the circuit from the battery to the heating element will be a closed circuit and that there is no bare wire exposed to short with the operator, tools, equipment, etc. The rubber coating prevents the battery from causing a short with any external metallic material or with electrical circuits causing malfunction with equipment.

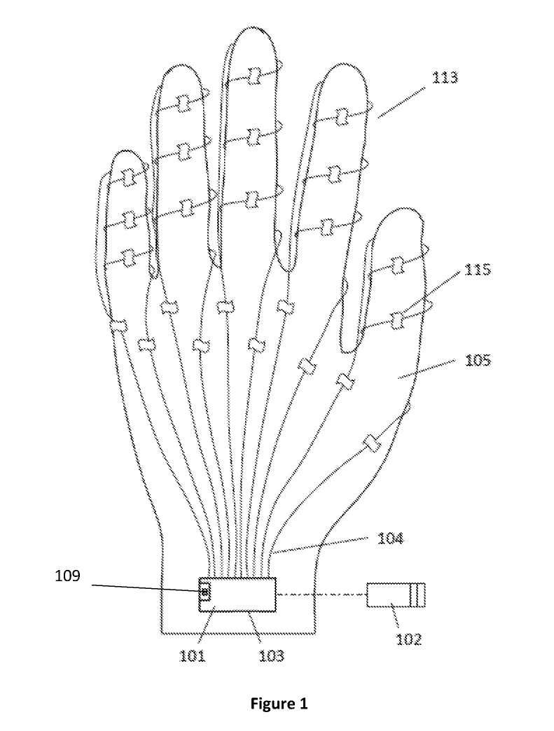

FIG. 1 shows the overview 113 of the heated garment in the shape of a glove. In use, the wearer may pull open a flap to insert rechargeable battery 102 into battery socket 101. The switch 109 may then be toggled to an “on” setting, such that current will begin to flow through the heating element 104 to heat the glove. The heating element 104 can supply heat to at least about 80% of the hand and appendage regions, or at least about 90% of the hand and appendage regions, or at least about 95% of the hand and appendage regions.

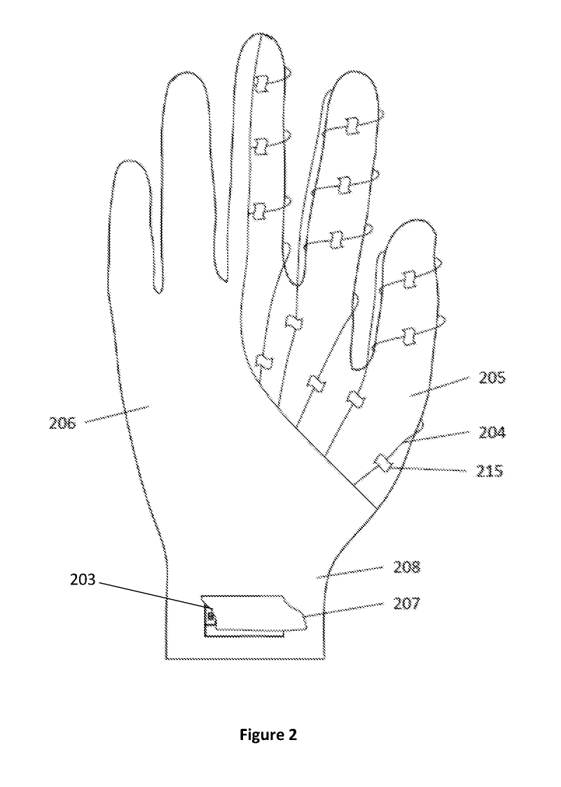

FIG. 2 shows the heating element 204 as it is layered between ambient-facing outer layer 206 and inner layer 205 that conforms to the wearer for a snug and proper fit. The inner layer 205 and outer layer 206 can use fabric that conforms to a user's hand and can use little if any insulating material. Exemplary embodiments can use less than about 10 ounces of insulating material, less than about 5 ounces of insulating material, and less than about 3 ounces of insulating material. FIG. 2 demonstrates this relationship of the outer layer 206 and the inner layer 205 with the heating element 204 disposed there-between. A flap 207 is designed to provide access to the battery, and is located distal from the fingers, roughly proximate to the back of a wearer's wrist 208, as not to interfere with the objective or operation of the invention. The flap 207 is comprised of a slim design with respect to battery socket 201 and electronic holder 203. The electronic holder 203 is of a slim nature as to keep it from impeding with the work environment. The heating element 204 is shown loosely to reflect the relationship spatially, as shown with heating element 204 attached to the inner layer 205.

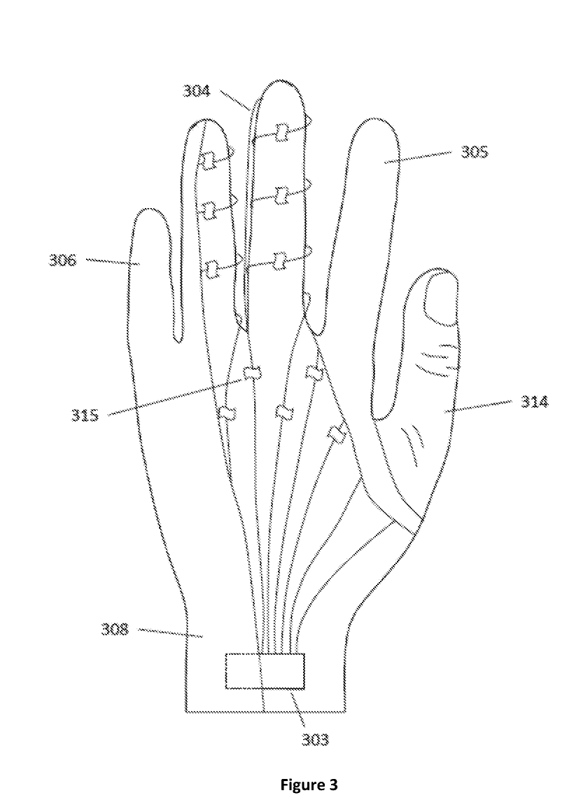

FIG. 3 shows the layers with spatial reference to the wearer's hand 314. The inner layer 305 and outer layer 306 respectively conform snuggly to the wearer's hand 314 to provide a wearer with free range of motion with little to no encumbrance that a traditional glove imposes on a wearer. These figures illustrate the high degree of conformity to the wearer's hand 314 without room for the hand to move freely within the glove itself, which would cause slippage and loss of proper grip on tools, equipment, objects, etc. that the wearer may be handling. The heating element 304 is also flexible to conform to the wearer's specific physiology, so as to not generate tension or unwanted resistance with loop fastening design 315. In one exemplary embodiment, the heating element 304 can be attached to the inner layer 305. The electronic holder 303 can be located near the wrist portion 308 of the glove.

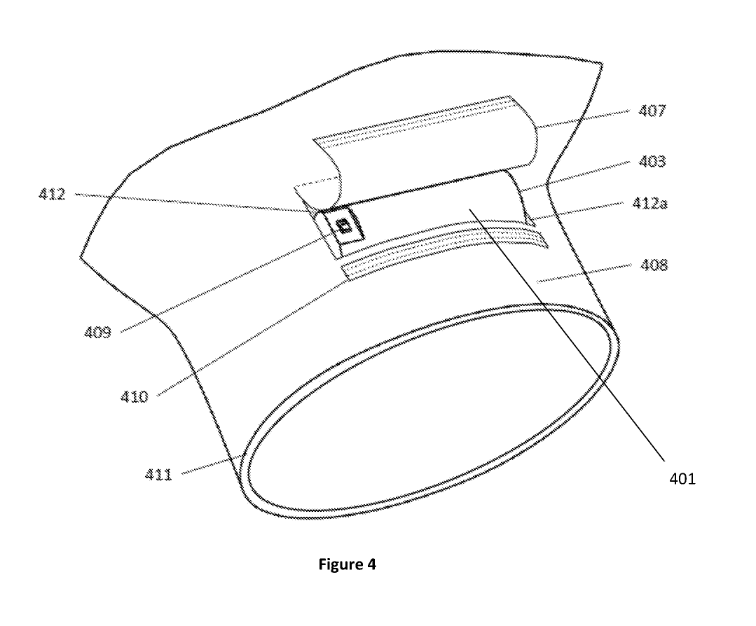

FIG. 4 shows various aspects of the glove, including battery socket 401, rechargeable battery 402, electronics housing component 403, flap component 407, switch 409, latch component 410, flexible band 411, pocket for battery holder 412, and intermediate layer 412a on the wrist band 408. Electronics holder 403 is directly connected to the inner layer 405 and the heating element 404. The flap 407 provides cover for electronics housing component 403 should the battery become dislodged.

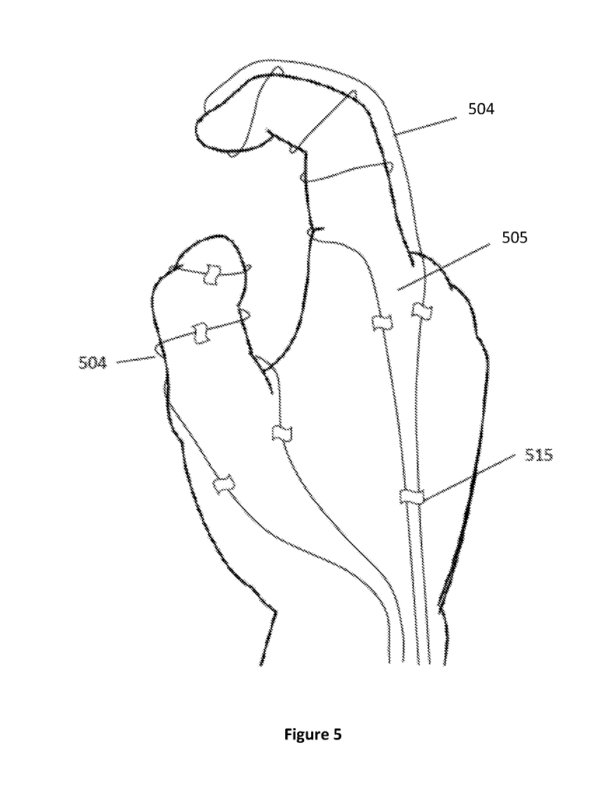

FIG. 5 shows the heating elements 504 that are used to bend and move with the wearer 514 utilizing the loop fastening design 515. In FIG. 5, the heating element 504 is shown in a cutaway from the garment to depict the relationship between the heating element 504 and the inner layer. The heating element 504 is physically attached to the inner layer 505 for a more sure, snug fit. The heating element 504 is embedded in an insulation as not to physically come in contact with any conductive element (tool, liquid, object, etc.).

The present invention has been described with reference to certain exemplary embodiments thereof. However, it will be readily apparent to those skilled in the art that it is possible to embody the invention in specific forms other than those of the exemplary embodiments described herein. This may be done without departing from the spirit of the invention. The exemplary embodiments are illustrative and should not be considered restrictive in any way. The scope of the invention is defined by the appended claims and their equivalents, rather than by the preceding description.

What is claimed is:

1. A heated glove suitable for use in cold temperature environments comprising:
a hand region;
a plurality of appendage regions;
a battery housing region;
an inner layer;
an outer layer; and
a heating element disposed between the inner layer and the outer layer,
wherein the heating element is electrically connected to the battery housing region, wherein the heating element is electrically isolated.

2. The glove of claim 1 wherein the battery housing region has a switch configured to control power output to said heating element.

3. The glove of claim 1 wherein the heating element supplies heat to at least about 80% of the hand and appendage regions.

4. The glove of claim 1 wherein the heating element supplies heat to at least about 90% of the hand and appendage regions.

5. The glove of claim 1 wherein the heating element supplies heat to at least about 95% of the hand and appendage regions.

6. The glove of claim 1 wherein the glove comprises less than about 10 ounces of insulating material.

7. The glove of claim 1 wherein the glove comprises less than about 5 ounces of insulating material.

8. The glove of claim 1 wherein the glove comprises less than about 3 ounces of insulating material.

9. The glove of claim 1, wherein the heating element is configured to coil around each appendage region and form a pattern throughout the hand region.

10. The glove of claim 9, wherein the glove further comprises a flap component proximate to the hand portion of the outer layer, wherein the flap component is configured to cover said battery housing, wherein said flap component is further configured to couple to a latch component.

11. The glove of claim 10, further comprising at least one loop securing feature, wherein said loop securing feature is configured to secure the heating element to the inner layer of the glove.

12. The glove of claim 11, wherein said loop securing feature is configured to allow the heating element to be moveable in between the inner layer and the outer layer.

13. The glove of claim 1, wherein the heating element is composed of a NiCr based metal.

14. The glove of claim 12, wherein the heating element is coated with a durable rubber coating.

15. A heated glove comprising:
an inner layer and an outer layer, wherein both the inner layer and outer layer have a hand region and a plurality of appendage regions, wherein the inner layer is configured to mate with the outer layer;
a heating element disposed between the inner layer and the outer layer, wherein said heating element is configured to coil around each appendage region and form a pattern throughout the hand region, wherein said heating element is further configured to be electrically isolated; and
a power source electrically connected to a power housing, wherein the heating element is electrically connected to the power housing, wherein the power source is configured to provide an electrical current to said heating element.

16. The glove of claim 15, wherein said power source is a battery.

17. The glove of claim 15, wherein said power source comprises a solar cell and a capacitor.

18. The glove of claim 15, wherein said power housing is distally located from the appendage regions.

19. The glove of claim 15, wherein the power housing further comprises a control mechanism configured to selectively apply current to the heating element and further configured to regulate the amount of current applied to the heating element.

20. The glove of claim 15, further comprising a plurality of loop securing features, wherein said loop securing features are configured to secure the heating element to the inner layer of the glove.
